(19) United States
(12) Patent Application Publication
(10) Pub. No.: US 2021/0062107 A1
(43) Pub. Date: Mar. 4, 2021

(54) STABILIZED CANDLE WAX COMPOSITIONS

(71) Applicant: MPT, Inc., McDonald, PA (US)

(72) Inventor: Tom Vetterly, McDonald, PA (US)

(21) Appl. No.: 17/006,604

(22) Filed: Aug. 28, 2020

Related U.S. Application Data
(60) Provisional application No. 62/893,833, filed on Aug. 30, 2019.

(51) Int. Cl. C11C 5/00

(52) U.S. Cl. CPC C11C 5/004

(57) ABSTRACT

Candle wax (which may be white or colored, and unscented or scented) is effectively stabilized against discoloration and fading by the incorporation therein of a liquid 2-hydroxybenzophenone ultraviolet absorber, either alone or in combination with a second UV absorber, a benzoate light stabilizer, an antioxidant, and/or a hindered amine light stabilizer (HALS).

### BACKGROUND OF THE INVENTION

Candles are widely used to provide accent lighting as well as functioning as delivery systems for fragrances. However, candles and their component substances (wax, fragrances, colorants, etc.) are subject to degradation when exposed to light. Undesirable changes occurring as a result of degradation include color fading and a loss or change of fragrance.

The light stabilization of candles is well known in the art. For example, at the National Candle Association Technical Meeting on Apr. 16, 1998, F. A. Ballentine et al. presented a paper entitled “Inhibiting Color Fading of Colored Candles with CYASORB® Light Absorbers” in which the general theories of thermal oxidation and photodegradation of organic materials were discussed along with data on the effect of ultraviolet absorbers of 2-hydroxyphenylbenzotriazole and 2-hydroxybenzophenone types on the color stability of colored candle waxes.

U.S. Pat. No. 5,964,905 discloses the use of ultraviolet absorbers (including 2-hydroxyphenylbenzotriazole and benzylidene malonate types) in colored and scented gel candles.

Stabilized candle wax compositions comprising combinations of ultraviolet absorbers with N-alkoxy, N-cycloalkoxy, or N-hydroxy substituted hindered amine light stabilizers (HALS), and optionally further comprising antioxidants are disclosed in U.S. Pat. No. 6,221,115. The use of liquid 2-hydroxybenzophenone ultraviolet absorbers of the present invention alone or in combination with the selected HALS is not disclosed.

Stabilized candle wax compositions comprising red-shifted 2-hydroxyphenylbenzotriazole ultraviolet absorbers, and optionally further comprising HALS and/or antioxidants are disclosed in U.S. Pat. No. 6,296,674.

Stabilized candle wax compositions comprising bloom-resistant 2-hydroxyphenylbenzotriazole ultraviolet absorbers, and optionally further comprising HALS and/or antioxidants are disclosed in U.S. Pat. No. 6,508,847.

Stabilized candle wax compositions comprising combinations of 2-hydroxyphenyltriazine ultraviolet absorbers and HALS, and optionally further comprising an additional ultraviolet absorber and/or an antioxidant are disclosed in U.S. Pat. No. 6,562,083. The use of liquid 2-hydroxybenzophenone ultraviolet absorbers of the present invention alone or in combination with the selected 2-hydroxyphenyltriazine ultraviolet absorbers and HALS is not disclosed.

Stabilized candle wax compositions comprising a combination of an ultraviolet absorber and a metal compound, and optionally further comprising an antioxidant and/or HALS are disclosed in U.S. Pat. No. 6,562,085. The use of liquid 2-hydroxybenzophenone ultraviolet absorbers of the present invention alone or in combination with the selected metal compounds is not disclosed.

Stabilized candle wax compositions comprising long-chain HALS, and optionally further comprising ultraviolet absorbers and/or antioxidants are disclosed in U.S. Pat. No. 6,699,298. The use of liquid 2-hydroxybenzophenone ultraviolet absorbers of the present invention alone or in combination with the selected long-chain HALS is not disclosed.

A method of incorporating an antioxidant into a fragranced candle, comprising the addition of a solution of a fragrance, an antioxidant, and optionally a diluent to a candle wax melt which may contain HALS and/or a color additive is disclosed in U.S. Pat. No. 7,220,288.

Stabilized fragranced candle compositions comprising one or more ultraviolet absorbers and a benzoate light stabilizer, and optionally further comprising a colorant and/or an antioxidant are disclosed in US Patent Application Publication US2004/0068920 A1. The use of liquid 2-hydroxybenzophenone ultraviolet absorbers of the present invention alone or in combination with the selected benzoate light stabilizers is not disclosed.

Stabilized candle wax compositions comprising ultraviolet absorber/HALS molecular combinations, and optionally further comprising an antioxidant are disclosed in U.S. Pat. No. 7,419,513.

Stabilized candle wax compositions comprising combinations of ultraviolet absorbers and HALS obtained by esterification of 1-(2-hydroxyethyl)-2,2,6,6-tetramethyl-4-hydroxypiperidine with monofunctional carboxylic acids, and optionally further comprising a second HALS and/or an antioxidant are disclosed in US Patent Application Publication US2018/0002527 A1. The use of liquid 2-hydroxybenzophenone ultraviolet absorbers of the present invention alone or in combination with the selected HALS is not disclosed.

None of these references teach the superior performance that is unexpectedly provided when the liquid 2-hydroxybenzophenone ultraviolet absorbers of the present invention (for example 2-hydroxy-4-isooctyloxybenzophenone) are used in place of solid 2-hydroxybenzophenone ultraviolet absorbers of the prior art (for example 2-hydroxy-4-octyloxybenzophenone).

### SUMMARY OF THE INVENTION

It has been found that candle wax, which may be white or colored, and unscented or scented, can be more effectively stabilized by the addition of selected liquid 2-hydroxybenzophenone ultraviolet absorbers as compared to candle wax stabilized with conventional solid 2-hydroxybenzophenone ultraviolet absorbers of the prior art. The liquid 2-hydroxybenzophenone ultraviolet absorbers can be employed either alone or in combination with additional ultraviolet absorbers, benzoate light stabilizers, phenolic antioxidants, and/or hindered amine light stabilizers (HALS).

### DETAILED DESCRIPTION OF THE INVENTION

The instant invention pertains to a composition, which comprises the following components:

(a) Candle wax, which may be white or colored, and unscented or scented, and

(b) An effective stabilizing amount of a liquid 2-hydroxybenzophenone ultraviolet absorber, where an effective stabilizing amount of component (b) is between 0.01 and 10% by weight, preferably between 0.1 to 2% by weight, and most preferably between 0.1 and 1% by weight.

Waxes suitable for use as component (a) of the inventive compositions are well known in the art, including animal waxes such as beeswax, vegetable waxes such as soy wax, petroleum waxes such as paraffin wax, and synthetic waxes. The waxes may be white or natural in color or contain added colorants such as dyes and pigments. The waxes may also be unscented or scented by the addition of fragrances.

Liquid 2-hydroxybenzophenone ultraviolet absorbers suitable for use as component (b) of the inventive compositions are known in the art, for example 2-hydroxy-4-alkoxybenzophenones of the formula (I), where R is a mixture of random branched alkyl groups (referred to in the art as “isoalkyl groups”) having from about 6 to about 12 carbon atoms. The compounds, methods for their preparation, and stabilized polymer compositions comprising them are disclosed in U.S. Pat. Nos. 3,658,910 and 3,729,442.

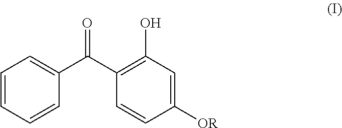

Most preferably, the liquid benzophenone ultraviolet absorber is 2-hydroxy-4-isooctyloxybenzophenone, Chemical Abstract Service (CAS) No. 33059-05-1.

In a second embodiment, the composition further comprises as component (c) one or more additional ultraviolet absorbers, wherein the total concentration of components (b) and (c) is between 0.01 and 10% by weight, preferably between 0.1 to 2% by weight, and most preferably between 0.1 and 1% by weight; and the ratio by weight of component (b) to component (c) is from 10:1 to 1:10, preferably from 4:1 to 1:4, and most preferably from 2:1 to 1:2.

The ultraviolet absorber for use as component (c) of the inventive compositions is selected from the groups consisting of solid 2-hydroxybenzophenones, 2-hydroxyphenylbenzotriazoles, 2-hydroxyphenyltriazines, .alpha.-cyanoacrylates, oxalanilides, and formamidines. Examples of ultraviolet absorbers that are suitable for use as component (c) of the inventive compositions include the following:
2,2′-Dihydroxy-4-methoxybenzophenone, CAS No. 131-53-3;
2,2′-Dihydroxy-4,4′-dimethoxybenzophenone, CAS No. 131-54-4;
2,2′,4,4′-Tetrahydroxybenzophenone, CAS No. 131-55-5;
2-Hydroxy-4-methoxybenzophenone, CAS No. 131-57-7;
2-Hydroxy-4-octyloxybenzophenone, CAS No. 1843-05-6;
2-(2H-Benzotriazol-2-yl)-4-methylphenol, CAS No. 2440-22-4;
2-(4,6-Bis(2,4-dimethylphenyl)-1,3,5-triazin-2-yl)-5-(octyloxy)phenol, CAS No. 2725-22-6;
2-(2H-Benzotriazol-2-yl)-4-(1,1,3,3-tetramethylbutyl)phenol, CAS No. 3147-75-9;
2-(5-Chloro-2H-benzotriazol-2-yl)-6-(1,1-dimethylethyl)-4-methylphenol, CAS No. 3896-11-5;
Ethyl 2-cyano-3,3-diphenylacrylate, CAS No. 5232-99-5;
2-Ethylhexyl 2-cyano-3,3-diphenylacrylate, CAS No. 6197-30-4;
2-Ethoxy-2′-ethyloxanilide, CAS No. 23949-66-8;
2-(2H-Benzotriazol-2-yl)-4,6-di-tert-pentylphenol, CAS No. 25973-55-1;
N-(4-ethoxycarbonylphenyl)N′-methyl-N′-phenylformamidine, CAS No. 57834-33-0;
2-(2H-Benzotriazol-2-yl)-4,6-bis(1-methyl-1-phenylethyl)phenol, CAS No. 70321-86-7;
2-(2H-Benzotriazol-2-yl)-6-(1-methyl-1-phenylethyl)-4-(1,1,3,3-tetramethylbutyl)phenol, CAS No. 73936-91-1;
A mixture of octyl 3-(3-tert-butyl-4-hydroxy-5-(5-chloro-2H-benzotriazol-2-yl)phenyl)propionate and 2-ethylhexyl 3-(3-tert-butyl-4-hydroxy-5-(5-chloro-2H-benzotriazol-2-yl)phenyl)propionate, CAS Nos. 83044-89-7 and 83044-90-0;
Methyl 3-(3-tert-butyl-4-hydroxy-5-(5-chloro-2H-benzotriazol-2-yl)phenyl)propionate, CAS No. 83044-91-1;
Methyl 3-(3-tert-butyl-5-(2H-benzotriazol-2-yl)-4-hydroxyphenyl)propionate, CAS No. 84268-33-7;
2,2′-Methylenebis(6-(2H-benzotriazol-2-yl)-4-(1,1,3,3-tetramethylbutyl)phenol), CAS No. 103597-45-1;
A mixture of alpha-3-(3-(2H-benzotriazol-2-yl)-5-tert-butyl-4-hydroxyphenyl)propionyl-omega-hydroxypoly(oxyethylene) and alpha-3-(3-(2H-benzotriazol-2-yl)-5-tert-butyl-4-hydroxyphenyl)propionykomega-3-(3-(2H-benzotriazol-2-yl)-5-tert-butyl-4-hydroxyphenyl)propionyloxypoly(oxyethylene), CAS Nos. 104810-48-2 and 104810-47-1;
2-(2H-benzotriazol-2-yl)-6-dodecyl-4-methylphenol, branched and linear, CAS No. 125304-04-3;
A mixture of branched and linear C₇-C₉ alkyl esters of 3-(3-tert-butyl-4-hydroxy-5-(5-chloro-2H-benzotriazol-2-yl)phenyl)propionic acid, CAS No. 127519-17-9;
2-(4,6-Diphenyl-1,3,5-triazin-2-yl)-5-((hexyl)oxy)phenol, CAS No. 147315-50-2;
A mixture of 2-[4-[(2-hydroxy-3-dodecyloxypropyl)oxy]-2-hydroxyphenyl]-4,6-bis(2,4-dimethylphenyl)-1,3,5-triazine and 2-[4-[(2-hydroxy-3-tridecyloxypropyl)oxy]-2-hydroxyphenyl]-4,6-bis(2,4-dimethylphenyl)-1,3,5-triazine, CAS No. 153519-44-9; and
2-(4,6-Bis((1,1′-biphenyl)-4-yl)-1,3,5-triazin-2-yl)-5-((2-ethylhexyl)oxy)phenol, CAS No. 204583-39-1.

A third embodiment is a composition comprising components (a) and (b) as defined previously and further comprising as component (d) one or more benzoate light stabilizers, wherein the total concentration of components (b) and (d) is between 0.01 and 10% by weight, preferably between 0.1 to 2% by weight, and most preferably between 0.1 and 1% by weight; and the ratio by weight of component (b) to component (d) is from 10:1 to 1:10, preferably from 4:1 to 1:4, and most preferably from 2:1 to 1:2. It is anticipated that the inventive compositions of this embodiment may further comprise component (c) as defined previously.

Benzoate light stabilizers that are suitable for use as component (d) in the inventive compositions are selected from alkyl and aryl esters of 3,5-di-tert-butyl-4-hydroxybenzoic acid. Examples of benzoate light stabilizers suitable for use as component (d) in the inventive compositions include the following:
Ethyl 3,5-di-tert-butyl-4-hydroxybenzoate, CAS No. 1620-64-0;
3,5-Di-tert-butyl-4-hydroxy-(2,4-di-tert-butylphenyl)benzoate, CAS No. 4221-80-1; and
Palmityl 3,5-di-tert-butyl-4-hydroxybenzoate, CAS No. 67845-93-6.

A fourth embodiment is a composition comprising components (a) and (b) as defined previously and further comprising as component (e) one or more hindered phenolic antioxidants, wherein the total concentration of components (b) and (e) is between 0.01 and 10% by weight, preferably between 0.1 to 2% by weight, and most preferably between 0.1 and 1% by weight; and the ratio by weight of component (b) to component (e) is from 10:1 to 1:10, preferably from 5:1 to 1:5, and most preferably from 3:1 to 1:3. It is anticipated that the inventive compositions of this embodiment may further comprise components (c) and/or (d) as defined previously.

Examples of hindered phenolic antioxidants that are suitable for use as component (e) of the inventive compositions include the following:
2,2′-Methylenebis(4-ethyl-6-tert-butylphenol), CAS No. 88-24-4;
4,4′-Methylenebis(2,6-di-tert-butylphenol), CAS No. 118-82-1;
2,2′-Methylenebis(4-methyl-6-tert-butylphenol), CAS No. 119-47-1;
2,6-Di-tert-butyl-4-methylphenol, CAS No. 128-37-0;
Tocopherol, CAS No. 1406-66-2;
1,3,5-Dimethyl-2,4,6-tris(3,5-tert-butyl-4-hydroxybenzyl)benzene, CAS No. 1709-70-2;

1,1,3-Tris(2′-methyl-4′-hydroxy-5′-tert-butylphenyl)butane, CAS No. 1843-03-4;

tert-Butylhydroquinone, CAS No. 1948-33-0;
Octadecyl 3-(3,5-di-tert-butyl-4-hydroxyphenyl)propionate, CAS No. 2082-79-3;
2,6-Di-tert-butyl-4-nonylphenol, CAS No. 4306-88-1;
Methyl 3-(3,5-di-tert-butyl-4-hydroxyphenyl)propionate, CAS No. 6386-38-5;
Pentaerythritol tetrakis(3-(3,5-di-tert-butyl-4-hydroxyphenyl)propionate), CAS No. 6683-19-8;
4-sec-Butyl-2,6-di-tert-butylphenol, CAS No. 17540-75-9;
N,N′-Hexane-1 ,6-diylbis[3-(3,5-di-tert-butyl-4-hydroxyphenylpropionamide], CAS No. 23128-74-7;
Ethylene bis(3,3-bis(3-tert-butyl-4-hydroxyphenyl)butyrate), CAS No. 32509-66-3;
Hexamethylene bis(3-(3,5-di-tert-butyl-4-hydroxyphenyl)propionate), CAS No. 35074-77-2;
2,2′-Ethylenebis(4,6-di-tert-butylphenol), CAS No. 35958-30-6;
Triethylene glycol bis[3-(3-tert-butyl-4-hydroxy-5-methylphenyl)propionate], CAS No. 36443-68-2;
Thiodiethylene bis(3-(3,5-di-tert-butyl-4-hydroxyphenyl)propionate), CAS No. 41484-35-9;
2,2′-Methylenebis(4-methyl-6-tert-butylphenol) monoacrylate, CAS No. 61167-58-6;
4-Methylphenol, reaction products with dicyclopentadiene and isobutylene, CAS No. 68610-51-5;
2,2′-Ethylidenebis(4,6-di-tert-amylphenol) monoacrylate, CAS No. 123968-25-2;
3-(3,5-di-tert-butyl-4-hydroxyphenyl)propionic acid, branched C₇-C₉ alkyl esters, CAS No. 125643-61-0;
3-(3,5-di-tert-butyl-4-hydroxyphenyl)propionic acid, C₁₃-C₁₅ alkyl esters, CAS No. 171090-93-0; and
3-(3,5-di-tert-butyl-4-hydroxyphenyl)propionic acid, branched tridecyl ester, CAS No. 847488-62-4.

A fifth embodiment is a composition comprising components (a) and (b) as defined previously and further comprising as component (f) one or more hindered amine light stabilizers (HALS), wherein the total concentration of components (b) and (f) is between 0.01 and 10% by weight, preferably between 0.1 to 2% by weight, and most preferably between 0.1 and 1% by weight; and the ratio by weight of component (b) to component (e) is from 10:1 to 1:10, preferably from 4:1 to 1:4, and most preferably from 2:1 to 1:2. It is anticipated that the inventive compositions of this embodiment may further comprise components (c), (d), and/or (e) as defined previously.

Hindered amine light stabilizers (HALS) suitable for use as component (f) of the inventive compositions are well known in the art, for example compounds which contain a substituted 2,2,6,6-tetramethylpiperidine group of formula (II):

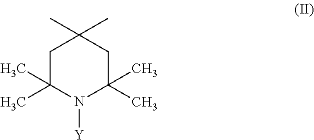

in which Y is hydrogen, methyl, alkyl (which may be unsubstituted or further substituted), acyl, or alkoxy (which may be unsubstituted or further substituted). Examples of HALS suitable for use as component (f) of the inventive compositions include the following:
Bis(1,2,2,6,6-pentamethyl-4-piperidyl) sebacate, CAS No. 41556-26-7;
A mixture of bis(1,2,2,6,6-pentamethyl-4-piperidyl) sebacate and methyl 1,2,2,6,6-pentamethyl-4-piperidyl sebacate, CAS Nos. 41556-26-7 and 82919-37-7;
1-(2-hydroxyethyl)-2,2,6,6-tetramethyl-4-hydroxypiperidine, CAS No. 52722-86-8;
Esters of 1-(2-hydroxyethyl)-2,2,6,6-tetramethyl-4-hydroxypiperidine (CAS No. 52722-86-8) with monofunctional carboxylic acids of one to about twenty two carbon atoms, which may be linear or branched, and saturated, mono-unsaturated, or polyunsaturated;
Bis(2,2,6,6-tetramethyl-4-piperidyl) sebacate, CAS No. 52829-07-9;
Bis(1,2,2,6,6-pentamethyl-4-piperidinyl)-2-butyl-2-(4-hydroxy-3,5-di-tert-butylbenzyl) propanedioate, CAS No. 63843-89-0;
1,2,3,4-Butanetetracarboxylic acid, tetrakis(2,2,6,6-tetramethyl-4-piperidinyl) ester, CAS No. 64022-61-3;
Dimethyl succinate-1-(2-hydroxyethyl)-4-hydroxy-2,2,6,6-tetramethylpiperidine copolymer, CAS No. 65447-77-0;
3-Dodecyl-1-(2,2,6,6-tetramethyl-4-piperidyl)pyrrolidine-2,5-dione, CAS No. 79720-19-7;
A mixture of 7-oxa-3,20-diazadispiro(5.1.11.2)heneicosane-20-propanoic acid, 2,2,4,4-tetramethyl-21-oxo-, dodecyl ester and 7-oxa-3,20-diazadispiro(5.1.11.2)heneicosane-20-propanoic acid, 2,2,4,4-tetramethyl-21-oxo-, tetradecyl ester, CAS Nos. 85099-51-0 and 85099-50-9;
A mixture of 2,2,6,6-tetramethylpiperidin-4-yl-hexadecanoate and 2,2,6,6-tetramethylpiperidin-4-yl-octadecanoate, CAS No. 86403-32-9;
1,2,3,4-Butanetetracarboxylic acid, tetrakis(1,2,2,6,6-pentamethyl-4-piperidinyl) ester, CAS No. 91788-83-9;
1,2,3,4-Butanetetracarboxylic acid, polymer with 2,2-bis(hydroxymethyl)-1,3-propanediol and 3-hydroxy-2,2-dimethylpropanal, 1,2,2,6,6-pentamethyl-4-piperidinyl ester, CAS No. 101357-36-2;
1,2,3,4-Butanetetracarboxylic acid, tetramethyl ester, reaction products with 2,2,6,6-tetramethyl-4 piperidinol and β, β, β′, β′-tetramethyl-2,4,8,10 -tetraoxaspiro[5.5]undecane-3,9-diethanol, CAS No. 101357-37-3;
3-Dodecyl-(1-(1,2,2,6,6-pentamethyl-4-piperidin)-yl)-2,5-pyrrolidindione, CAS No. 106917-30-0;
1-Acetyl-4-(3-dodecyl-2,5-dioxo-1-pyrrolidinyl)-2,2,6,6-tetramethylpiperidine, CAS No. 106917-31-1;
Bis(2,2,6,6-tetramethyl-4-piperidyl) sebacate, reaction products with tert-butyl hydroperoxide and octane, CAS No. 129757-67-1;
Alpha alkene (C₂₀-C₂₄) polymers with maleic anhydride, reaction products with 2,2,6,6-tetramethyl-4-piperidinamine (CAS Reg. No. 152261-33-1);
Fatty acids, C₁₂-₂₁ and C₁₈-unsaturated, 2,2,6,6-tetramethyl-4-piperidinyl esters, CAS No. 167078-06-0;
Octadecanoic acid, methyl ester, reaction products with 1-(2-hydroxy-2-methylpropoxy)-2,2,6,6-tetramethyl-4-piperidinol, CAS No. 300711-92-6; and
Bis(1-undecanoxy-2,2,6,6-tetramethylpiperidin-4-yl)carbonate, CAS No. 705257-84-7.

It should be noted that candles contain a host of various components. The base materials may be made up of the following: paraffin wax, vegetable wax, natural oils, polyamide plus fatty acid/ester, fatty acids such as stearin, opacifiers, beeswax, glycerides plus oxidized wax, alcohols, and ethylene oligomers.

Candles can also contain a number of additives such as mold release agents, fragrances, insect repellants or insecticides, hardeners, crystal modifiers, clarifiers, guttering reducers, colorants, f.p. control agents, stretchability improvers, gelling agents, extrusion aids, and vortex reducers. Each of the various components are meant to control or modify the properties of the candle to insure proper burning, reduce channeling, aid in uniform melting, and the like. The colorants and fragrances obviously are present to provide the proper color, scent or other aesthetic appeal.

### EXAMPLES

The following prophetic examples are meant for illustrative purposes only and are not to be construed to limit the instant invention in any manner whatsoever.

### Raw Materials

The following raw materials are used in the examples:
Soy wax, candle grade, from a commercial supplier;
Paraffin wax, candle grade, from a commercial supplier;
Vanilla fragrance, candle grade, from a commercial supplier;
Blue dye, candle grade, from a commercial supplier;
Red dye, candle grade, from a commercial supplier;
2-Hydroxy-4-isooctyloxybenzophenone, CAS No. 33059-05-1 (UV-531 L), liquid, from a commercial supplier;
2-Hydroxy-4-octyloxybenzophenone, CAS No. 1843-05-6 (UV-531), solid, from a commercial supplier;
2-(2H-Benzotriazol-2-yl)-4-(1,1,3,3-tetramethylbutyl)phenol, CAS No. 3147-75-9 (UV-329), from a commercial supplier;
Palmityl 3,5-di-tert-butyl-4-hydroxybenzoate, CAS No. 67845-93-6 (UV-2908), from a commercial supplier;
3-(3,5-di-tert-butyl-4-hydroxyphenyl)propionic acid, branched C₇-C₉ alkyl esters, CAS No. 125643-61-0 (AO-1135), from a commercial supplier; and
Bis(2,2,6,6-tetramethyl-4-piperidyl) sebacate, reaction products with tert-butyl hydroperoxide and octane, CAS No. 129757-67-1 (UV-123), from a commercial supplier.

### Testing Procedure

A mixture of soy wax and paraffin wax is added to a mixing vessel and heated to 85-90° C. to completely melt the wax. The components listed in the examples are added in amounts based on 100 parts of wax and stirred until completely homogeneous. The formulated wax is poured into glass Petri dishes and allowed to cool and solidify. The Petri dishes are exposed wax side up at a distance of 12 inches from a bank of fluorescent lamps for 28 days. The color of the wax is monitored at 7-day intervals and the extent of color fading between the examples and corresponding comparative examples of the prior art is compared.

### Examples 1-2 and Comparative Examples 1-2

### Color Fade of Colored, Unscented Candle Wax

| | Ex. 1 | Comp. Ex. 1 | Ex. 2 | Comp. Ex. 2 |
|---|---|---|---|---|
| Soy wax | 70 | 70 | 70 | 70 |
| Paraffin wax | 30 | 30 | 30 | 30 |
| Blue dye | 0.04 | 0.04 | — | — |
| Red dye | — | — | 0.04 | 0.04 |
| UV-531L | 0.2 | — | 0.2 | — |
| UV-531 | — | 0.2 | — | 0.2 |

Amounts are given in parts by weight.

The resistance to color fade of colored (blue and red), unscented candle wax compositions of the present invention (Examples 1-2) after 28 days of exposure to fluorescent lamps is found to be superior to candle wax compositions of the prior art (Comparative Examples 1-2).

### Examples 3-4 and Comparative Examples 3-4

### Color fade of Colored, Scented Candle Wax

| | Ex. 3 | Comp. Ex. 3 | Ex. 4 | Comp. Ex. 4 |
|---|---|---|---|---|
| Soy wax | 70 | 70 | 70 | 70 |
| Paraffin wax | 30 | 30 | 30 | 30 |
| Vanilla fragrance | 4 | 4 | 4 | 4 |
| Blue dye | 0.04 | 0.04 | — | — |
| Red dye | — | — | 0.04 | 0.04 |
| UV-531L | 0.6 | — | 0.6 | — |
| UV-531 | — | 0.6 | — | 0.6 |

Amounts are given in parts by weight.

The resistance to color fade of colored (blue and red), scented candle wax compositions of the present invention (Examples 3-4) after 28 days of exposure to fluorescent lamps is found to be superior to candle wax compositions of the prior art (Comparative Examples 3-4).

### Examples 5-6 and Comparative Examples 5-6

### Color fade of Colored, Unscented Candle Wax

| | Ex. 5 | Comp. Ex. 5 | Ex. 6 | Comp. Ex. 6 |
|---|---|---|---|---|
| Soy wax | 70 | 70 | 70 | 70 |
| Paraffin wax | 30 | 30 | 30 | 30 |
| Blue dye | 0.04 | 0.04 | — | — |
| Red dye | — | — | 0.04 | 0.04 |
| UV-531L | 0.1 | — | 0.1 | — |
| UV-531 | — | 0.1 | — | 0.1 |
| UV-329 | 0.1 | 0.1 | 0.1 | 0.1 |

Amounts are given in parts by weight.

The resistance to color fade of colored (blue and red), unscented candle wax compositions of the present invention (Examples 5-6) after 28 days of exposure to fluorescent lamps is found to be superior to candle wax compositions of the prior art (Comparative Examples 5-6).

### Examples 7-8 and Comparative Examples 7-8

### Color Fade of Colored, Scented Candle Wax

| | Ex. 7 | Comp. Ex. 7 | Ex. 8 | Comp. Ex. 8 |
|---|---|---|---|---|
| Soy wax | 70 | 70 | 70 | 70 |
| Paraffin wax | 30 | 30 | 30 | 30 |
| Vanilla fragrance | 4 | 4 | 4 | 4 |
| Blue dye | 0.04 | 0.04 | — | — |
| Red dye | — | — | 0.04 | 0.04 |
| UV-531L | 0.3 | — | 0.3 | — |
| UV-531 | — | 0.3 | — | 0.3 |
| UV-329 | 0.3 | 0.3 | 0.3 | 0.3 |

Amounts are given in parts by weight.

The resistance to color fade of colored (blue and red), scented candle wax compositions of the present invention (Examples 7-8) after 28 days of exposure to fluorescent lamps is found to be superior to candle wax compositions of the prior art (Comparative Examples 7-8).

### Examples 9-10 and Comparative Examples 9-10

### Color Fade of Colored, Unscented Candle Wax

| | Ex. 9 | Comp. Ex. 9 | Ex. 10 | Comp. Ex. 10 |
|---|---|---|---|---|
| Soy wax | 70 | 70 | 70 | 70 |
| Paraffin wax | 30 | 30 | 30 | 30 |
| Blue dye | 0.04 | 0.04 | — | — |
| Red dye | — | — | 0.04 | 0.04 |
| UV-531L | 0.1 | — | 0.1 | — |
| UV-531 | — | 0.1 | — | 0.1 |
| UV-2908 | 0.1 | 0.1 | 0.1 | 0.1 |

Amounts are given in parts by weight.

The resistance to color fade of colored (blue and red), unscented candle wax compositions of the present invention (Examples 9-10) after 28 days of exposure to fluorescent lamps is found to be superior to candle wax compositions of the prior art (Comparative Examples 9-10).

### Examples 11-12 and Comparative Examples 11-12

### Color Fade of Colored, Scented Candle Wax

| | Ex. 11 | Comp. Ex. 11 | Ex. 12 | Comp. Ex. 12 |
|---|---|---|---|---|
| Soy wax | 70 | 70 | 70 | 70 |
| Paraffin wax | 30 | 30 | 30 | 30 |
| Vanilla fragrance | 4 | 4 | 4 | 4 |
| Blue dye | 0.04 | 0.04 | — | — |
| Red dye | — | — | 0.04 | 0.04 |
| UV-531L | 0.3 | — | 0.3 | — |
| UV-531 | — | 0.3 | — | 0.3 |
| UV-2908 | 0.3 | 0.3 | 0.3 | 0.3 |

Amounts are given in parts by weight.

The resistance to color fade of colored (blue and red), scented candle wax compositions of the present invention (Examples 11-12) after 28 days of exposure to fluorescent lamps is found to be superior to candle wax compositions of the prior art (Comparative Examples 11-12).

### Examples 13-14 and Comparative Examples 13-14

### Color fade of Colored, Unscented Candle Wax

| | Ex. 13 | Comp. Ex. 13 | Ex. 14 | Comp. Ex. 14 |
|---|---|---|---|---|
| Soy wax | 70 | 70 | 70 | 70 |
| Paraffin wax | 30 | 30 | 30 | 30 |
| Blue dye | 0.04 | 0.04 | — | — |
| Red dye | — | — | 0.04 | 0.04 |
| UV-531L | 0.15 | — | 0.15 | — |
| UV-531 | — | 0.15 | — | 0.15 |
| AO-1135 | 0.05 | 0.05 | 0.05 | 0.05 |

Amounts are given in parts by weight.

The resistance to color fade of colored (blue and red), unscented candle wax compositions of the present invention (Examples 13-14) after 28 days of exposure to fluorescent lamps is found to be superior to candle wax compositions of the prior art (Comparative Examples 13-14).

### Examples 15-16 and Comparative Examples 15-16

### Color fade of Colored, Scented Candle Wax

| | Ex. 15 | Comp. Ex. 15 | Ex. 16 | Comp. Ex. 16 |
|---|---|---|---|---|
| Soy wax | 70 | 70 | 70 | 70 |
| Paraffin wax | 30 | 30 | 30 | 30 |
| Vanilla fragrance | 4 | 4 | 4 | 4 |
| Blue dye | 0.04 | 0.04 | — | — |
| Red dye | — | — | 0.04 | 0.04 |
| UV-531L | 0.4 | — | 0.4 | — |
| UV-531 | — | 0.4 | — | 0.4 |
| AO-1135 | 0.2 | 0.2 | 0.2 | 0.2 |

Amounts are given in parts by weight.

The resistance to color fade of colored (blue and red), scented candle wax compositions of the present invention (Examples 15-16) after 28 days of exposure to fluorescent lamps is found to be superior to candle wax compositions of the prior art (Comparative Examples 15-16).

### Examples 17-18 and Comparative Examples 17-18

### Color fade of Colored, Unscented Candle Wax

| | Ex. 17 | Comp. Ex. 17 | Ex. 18 | Comp. Ex. 18 |
|---|---|---|---|---|
| Soy wax | 70 | 70 | 70 | 70 |
| Paraffin wax | 30 | 30 | 30 | 30 |
| Blue dye | 0.04 | 0.04 | — | — |
| Red dye | — | — | 0.04 | 0.04 |
| UV-531L | 0.1 | — | 0.1 | — |
| UV-531 | — | 0.1 | — | 0.1 |
| UV-123 | 0.1 | 0.1 | 0.1 | 0.1 |

Amounts are given in parts by weight.

The resistance to color fade of colored (blue and red), unscented candle wax compositions of the present invention (Examples 17-18) after 28 days of exposure to fluorescent lamps is found to be superior to candle wax compositions of the prior art (Comparative Examples 17-18).

### Examples 19-20 and Comparative Examples 19-20

### Color fade of Colored, Scented Candle Wax

| | Ex. 19 | Comp. Ex. 19 | Ex. 20 | Comp. Ex. 20 |
|---|---|---|---|---|
| Soy wax | 70 | 70 | 70 | 70 |
| Paraffin wax | 30 | 30 | 30 | 30 |
| Vanilla fragrance | 4 | 4 | 4 | 4 |
| Blue dye | 0.04 | 0.04 | — | — |
| Red dye | — | — | 0.04 | 0.04 |
| UV-531L | 0.3 | — | 0.3 | — |
| UV-531 | — | 0.3 | — | 0.3 |
| UV-123 | 0.3 | 0.3 | 0.3 | 0.3 |

Amounts are given in parts by weight.

The resistance to color fade of colored (blue and red), scented candle wax compositions of the present invention (Examples 19-20) after 28 days of exposure to fluorescent lamps is found to be superior to candle wax compositions of the prior art (Comparative Examples 19-20).

I claim:

1. Compositions comprising (a) a candle wax, which may be white or colored and unscented or scented, and (b) an effective stabilizing amount of a liquid 2hydroxybenzophenone ultraviolet absorber represented by formula (I): 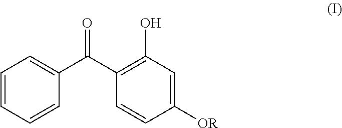
where R is a mixture of random branched alkyl groups having from about 6 to about 12 carbon atoms.

2. A composition according to claim 1, wherein component (b) is 2-hydroxy-4-isooctyloxybenzophenone.

3. A composition according to claim 1, which further comprises a second ultraviolet absorber (c) selected from the group consisting of solid 2-hydroxybenzophenones, 2-hydroxyphenylbenzotriazoles, 2-hydroxyphenyltriazines, .alpha.-cyanoacrylates, oxalanilides, and formamidines;
wherein the ratio by weight of component (b) to component (c) is between 10:1 and 1:10.

4. A composition according to claim 1, which further comprises a phenolic antioxidant (d), wherein the ratio by weight of component (b) to component (d) is between 10:1 and 1:10.

5. A composition according to claim 1, which further comprises a benzoate light stabilizer (e) selected from alkyl and aryl esters of 3,5-di-tert-butyl-4-hydroxybenzoic acid; wherein the ratio by weight of component (b) to component (e) is between about 10:1 and 1:10.

6. A composition according to claim 1, which further comprises a hindered amine light stabilizer (HALS) (f) selected from compounds which contain a substituted 2,2,6,6-tetramethylpiperidine group of formula (II): 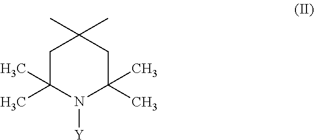
in which Y is hydrogen, methyl, alkyl (which may be unsubstituted or further substituted), acyl, or alkoxy (which may be unsubstituted or further substituted);
wherein the ratio by weight of component (b) to component (f) is between about 10:1 and 1:10.
